(19) United States
(12) Patent Application Publication
(10) Pub. No.: US 2010/0201035 A1
(43) Pub. Date: Aug. 12, 2010

(54) Concrete Infusion Casting

(76) Inventor: Charles H. Chambers, Granville, OH (US)

Correspondence Address: NIKOLAI & MERSEREAU, P.A., 900 SECOND AVENUE SOUTH, SUITE 820, MINNEAPOLIS, MN, 55402, US

(21) Appl. No.: 12/369,302

(22) Filed: Feb. 11, 2009

(51) Int. Cl. B28B 1/24

(52) U.S. Cl. 264/328.1; 425/585

(57) ABSTRACT

A technique and mechanized system for the production of precast concrete panel material by infusion of premixed concrete into a generally vertical moving form are disclosed. The technique includes infusing premixed concrete through a plurality of infusion nozzles through an infusion slot into an infusion chamber characterized by a hollow structure or form describing a panel shape which is defined by movable members that make up the interior surfaces of the hollow form structure and which move the infused material along at the rate of formation of the panel shape. The formed panel material is subjected to heat and pressure to effect a rapid cure sufficient to stabilize the structure by the time it is discharged from the discharge end of the infusion chamber.

### CROSS-REFERENCED TO RELATED APPLICATIONS

Not applicable

### STATEMENT REGARDING FEDERALLY SPONSORED RESEARCH OR DEVELOPMENT

Not applicable

### BACKGROUND OF THE INVENTION

I. Field of the Invention

The present invention relates generally to the production of precast concrete panels and, more particularly, to a process and plant or mechanized system for the continuous production of concrete panels using a continuous casting system that includes a generally vertical infusion chamber characterized by a hollow form describing a panel shape defined by movable members which is fed premixed concrete pumped by infusion nozzles through an infusion slot at the entry end of the form. The movable members advance at the rate of panel generation. Precast panels exiting the form structure are sufficiently cured to be handled in a vertical posture as panels.

II. Related Art

Precast concrete articles including panels for constructing concrete walls and buildings are known. In particular, precasting of panels using horizontally disposed stationary molds and forms for receiving pours of premixed concrete have been used for some time. The poured panels require a cure time of up to thirty (30) days before they can be safely handled by cranes or similar devices to load them onto transports and used in construction projects.

More recently, systems and processes have been devised to produce multiple cast concrete articles on a continuous basis using combined molding and conveying techniques. Examples of these are found in Zan (U.S. Pat. No. 4,952,129) and Pardo (U.S. Pat. No. 4,909,717). It is also known to manufacture precast reinforced concrete panels that have edge structures designed to fit together to create a composite structure such as a wall. Examples are depicted in Larson et al (U.S. Pat. No. 5,029,426) and Mossi (U.S. Pat. No. 6,071,458).

While known techniques and systems have generally met with success and have simplified building construction, the molds or forms generally take up a great deal of space and the cast panels or other shapes require a relatively long cure time before they can be moved and used as designed. Thus, there remains a definite need to improve the production of precast concrete building panels and other cast forms, particularly in terms of reducing required production space and cure time to use.

### SUMMARY OF THE INVENTION

By means of the present invention, there is provided a technique and plant or mechanized system for the production of precast concrete panel material by infusion of premixed concrete into a generally vertical infusion chamber form. The technique includes infusing premixed concrete through a plurality of infusion nozzles through an infusion slot into an infusion chamber characterized by a hollow structure or form describing the panel shape to be produced. The hollow structure or form is defined by a plurality of movable members that define the interior surfaces of the hollow form structure and which cooperate to move the infused material along at the rate of formation of the panel shape. The formed panel material is subjected to heat and pressure to effect a rapid cure sufficient to stabilize the structure by the time it is discharged from the discharge end of the infusion chamber.

In a preferred embodiment, premixed, low slump concrete material is introduced into the hollow form structure through a vertical slot using a plurality of sets of converging infusion nozzles which are operated to pivot vertically and cover the length of the infusion slot from bottom to top, thereby filling the hollow form structure. Preferably, the nozzles are in the form of spaced pairs of converging nozzles which are pivoted generally through about 90° from a downward angle of about 45° to an upward angle of about 45° such that the entire slot is infused in an orderly fashion. The nozzles are fed premixed concrete material using a pump and splitter arrangement to supply substantially equal amounts of material to all nozzles. High pressure air is also supplied to the nozzles to infuse the concrete in a pressurized manner.

The mechanized system for generating the infused precast concrete panels is in the form of an elongated self-contained manufacturing plant in which low slump concrete is infused and sufficiently cured under heat and pressure to enable handling of panels exiting the elongated apparatus. Generally, in one embodiment, the rate of panel generation may be about 1 foot per minute for an 8 inch thick panel having a height of about 8 feet. Thus, for a plant having an infusion chamber about 300 feet long, the concrete may have a dwell time of about 5 hours.

The system includes a housing reinforced by a heavy external structural frame. A generally vertical infusion chamber defines a hollow structure or form describing the panel to be cast. The hollow structure or form is defined by a plurality of endless belt members supported by heavy-duty intermeshing roller systems carried by structural frame members. These include bottom and side belts which run the length of the infusion chamber of the manufacturing plant. A shorter top belt is provided which imparts an edge shape to the top of the panel as it is generated. The belts are operated by a coordinated drive system so that a continuous panel is cast and moved along the hollow form structure at the rate of panel generation.

The plant or mechanized system also includes a source of heat, preferably steam, to heat the entire infusion chamber such that heat is transmitted to the moving concrete through the endless belts. The side or vertical belts which are generally vertically disposed are also enabled to be adjusted laterally about a centerline so that the thickness of a slab generated can be varied.

The concrete supply system includes a pump and splitter arrangement that supplies generally equal amounts of low slump concrete to the infusion nozzles from a source of premixed concrete. A source of high pressure air is also provided which is introduced into each of the infusion nozzles just above an infusion tip such that the concrete is blown into the infusion chamber under high pressure. The air may be supplied at 100 psi or above. The concrete is pressurized and squeezed even further as it progresses through the initial entry portion of the hollow form structure.

### BRIEF DESCRIPTION OF THE DRAWINGS

In the drawing wherein like reference characters represent like parts throughout the same:

FIG. 1 is a schematic perspective view of an embodiment of a mechanized concrete infusion system or manufacturing plant suitable for producing precast concrete panels in accordance with the present invention;

FIGS. 2A and 2B are top and side schematic views, respectively, of an embodiment of the concrete infusion system of the present invention with parts broken or removed so that some details may be shown for clarity;

FIG. 3 is an enlarged schematic vertical, cross-sectional representation, with parts broken, of the system of FIGS. 2A and 2B showing certain internal details;

FIGS. 4A and 4B represent greatly enlarged fragmentary top and end views showing an intermeshing roller support structure in accordance with the invention;

FIG. 5 is a greatly enlarged fragmentary detail of a portion of an embodiment of endless belts and support structure;

FIGS. 6A and 6B depict an embodiment of a swiveling infusion nozzle and mounting system in accordance with the invention;

FIGS. 7A and 7B are top and vertical cross-sectional views showing a splitter arrangement for supplying concrete to a plurality of infusion nozzles in accordance with the invention; and

FIG. 8 is a schematic representation of an infusion system in accordance with the invention.

### DETAILED DESCRIPTION

There follows a detailed description of an embodiment of the present invention which is presented as an example of a typical embodiment to allow an understanding of the inventive concepts involving the continuous production of concrete panel units. It will be understood, however, that the embodiment presented is intended merely as an example and is not meant to limit the scope of the invention in any manner.

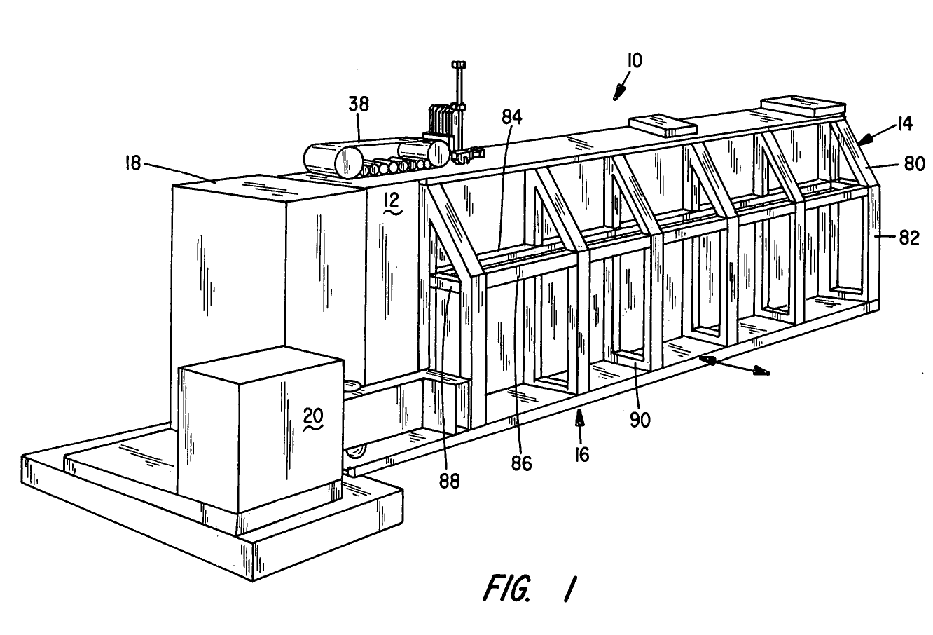

In FIG. 1, there is shown a schematic perspective representation of an embodiment of a plant for producing concrete panels in accordance with the present invention. The plant, shown generally by the reference character 10, includes a mechanized continuous infusion casting system for the continuous production of precast concrete panels. The housing for the mechanized system includes similar or identical spaced sidewalls, one of which is shown at 12. The spaced parallel sidewalls define a gap therebetween which is related to the thickness of a precast panel produced by the mechanized system. The sidewalls are buttressed by a heavy structural framework, generally denoted by the number 14, described in greater detail below. The framework is mounted on a base in a manner that enables the gap between spaced buttressed sidewall assemblies to be adjusted a minor amount about a centerline to thereby adjust the thickness of a corresponding precast panel may be adjusted. The system further includes an infusion housing 18 and a pump housing 20 which also will be described in greater detail below.

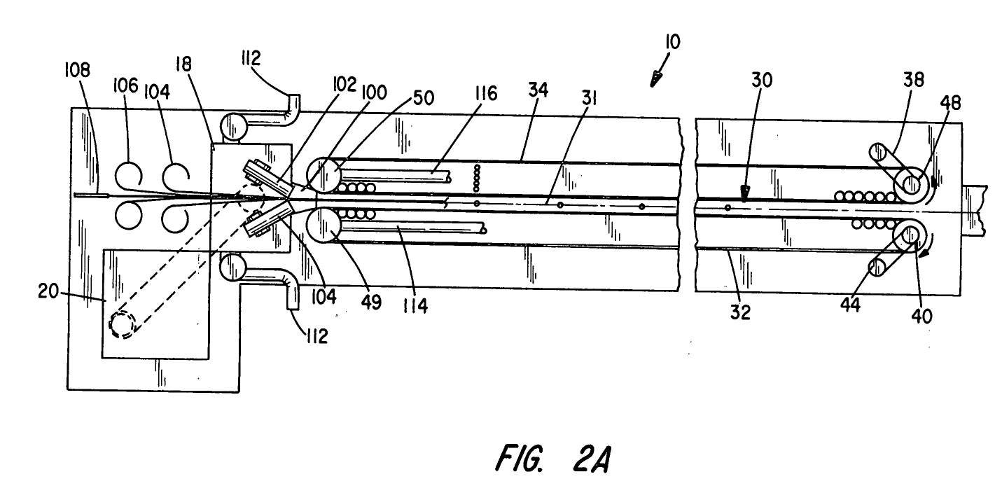

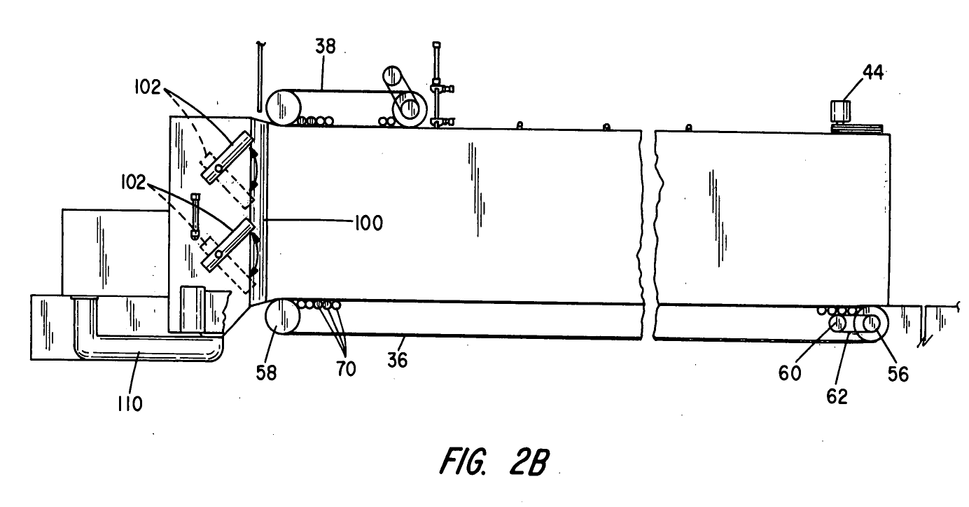

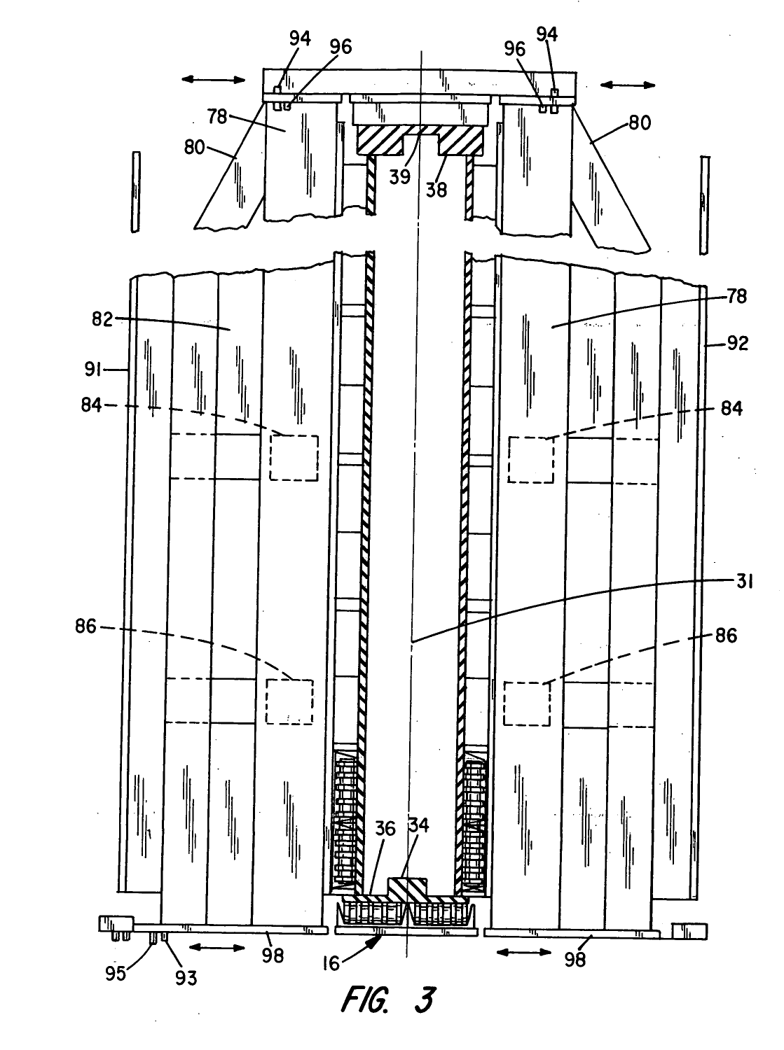

FIGS. 2A and 2B depict top and side elevational schematic views of the internal workings of a precast panel infusion system in accordance with the invention. The system includes an infusion chamber 30 having a centerline 31 width defined by a pair of vertically disposed endless belts 32 and 34 spanned by a bottom belt 36 which together define a vertical infusion chamber characterized by a hollow structure or form describing the shape of a panel to be produced. An upper, generally horizontal, relatively shorter, belt 38 is provided to contact and shape the top of the infused material as also shown in FIG. 3. Endless side belt 32 is mounted between a head pulley 40 and a tail pulley 42. The head pulley is driven by a variable speed system that includes a motor 44 and a drive belt 46. Likewise, endless side belt 34 is mounted on head pulley 48 and tail pulley 50 with pulley 48 being driven by motor 52 and drive belt 54; and bottom endless belt 36 is mounted between head pulley 56 and tail pulley 58 and driven by motor 60 and drive belt 62.

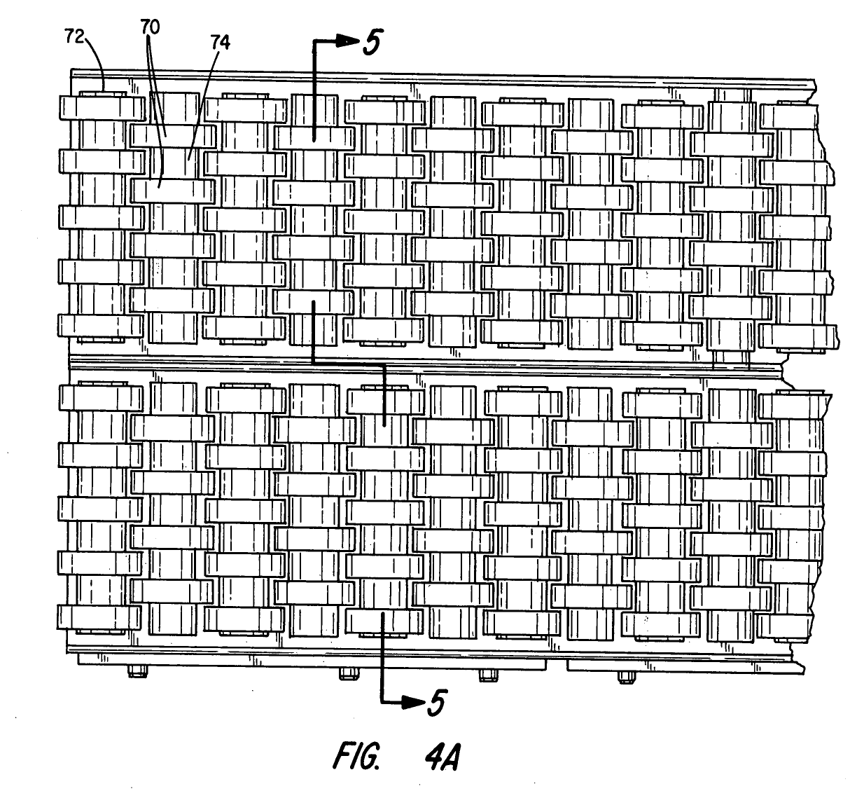

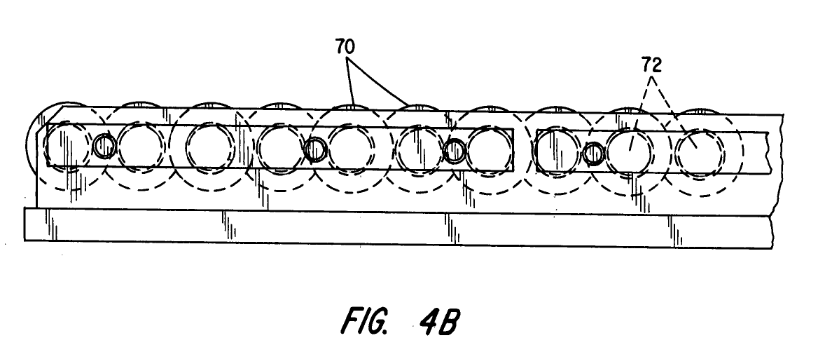

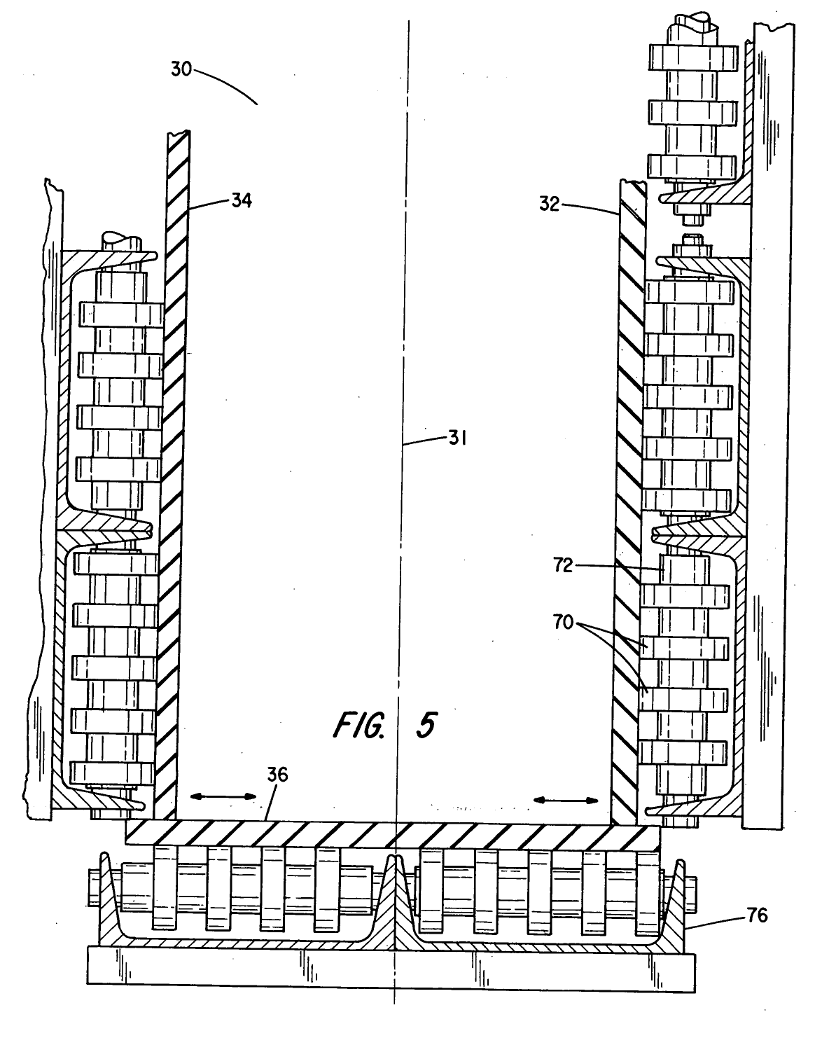

As best seen in FIGS. 3-5, the locations of the three endless belts 32, 34, 36 cooperate to define the hollow form or infusion chamber 30 that describes the panel shape to be produced. As seen in FIG. 5, the thickness of an infused precast panel can be varied. This is accomplished by adjusting the gap between the belts 32 and 34 about the centerline 31. This is accomplished by slight lateral adjustment of the support structure, as will be explained.

It will be appreciated that the weight of infused concrete concentrated on the belt 36 is considerable and the sidewalls defined by belts 32 and 34 are also designed to apply considerable horizontal or lateral force against the precast panel material as it moves through the chamber 30. Accordingly, the belts 32, 34, 36 must be supported or buttressed by an adequate support structure. As can be seen particularly in FIGS. 3-5, the system is provided with a series of intermeshing rollers 70 mounted on heavy-duty shafts 72 and spaced by spacer collars 74. Shafts 72, in turn, are mounted in openings in structural channel members 76 which in the case of side members are buttressed by other structural members and the supporting framework 14.

The supporting framework includes columns as at 78 (FIGS. 1 and 3) which are further supported by outer structural members as shown in FIG. 1 which include angled structural members 80 connected between column 78 and vertical members 82. The column 78 and outer vertical members 82 are interconnected by inner and outer horizontal structural members 84 and 86, respectively, and upper and lower cross-struts 88 and 90. Outer wall panels are shown at 91 and 92. The channel members carrying the roller matrix supporting the bottom endless belt 36 are supported by the system base 16.

As also shown in FIG. 3, side support structures 14 are mounted on movable die systems which enable slight lateral adjustments which, in turn, affects the width of the infusion chamber enabling panels of differing thicknesses to be cast. Thus, in the view of FIG. 3, the width of the chamber 30 is shown to accommodate an 8 inch (20.3 cm) thick panel. The structures 14 are held in place by a plurality of bolts or pins as at 93 and 94. Alternate positions as at 95 and 96 may accommodate a 10 inch (25.4 cm) wall, for example. While these are shown for one side, it will be appreciated that both side frames will move similarly about centerline 31. The bolts are removed and the structure moved to another desired key location where the bolts are replaced in the new alternate location where the structures are again locked in position as shown with reference to a top bridge 97 and bottom plate 98.

It will be appreciated that each of the rollers 70 as mounted for rotation on a shaft 72 includes appropriate ball or roller bearings as are readily available. The intermeshed design provides continuous support to a precast panel as it is processed along the generally vertical infusion chamber 30 using moving belts 32, 34, 36. As shown in FIG. 3, it will further be appreciated that the moving bottom belt 36 may be provided with a tongue form as at 37 and the top belt 38, a groove form as at 39, enabling the panels to be produced with a tongue and groove or similar arrangement so that cured panels may be later assembled together in this manner.

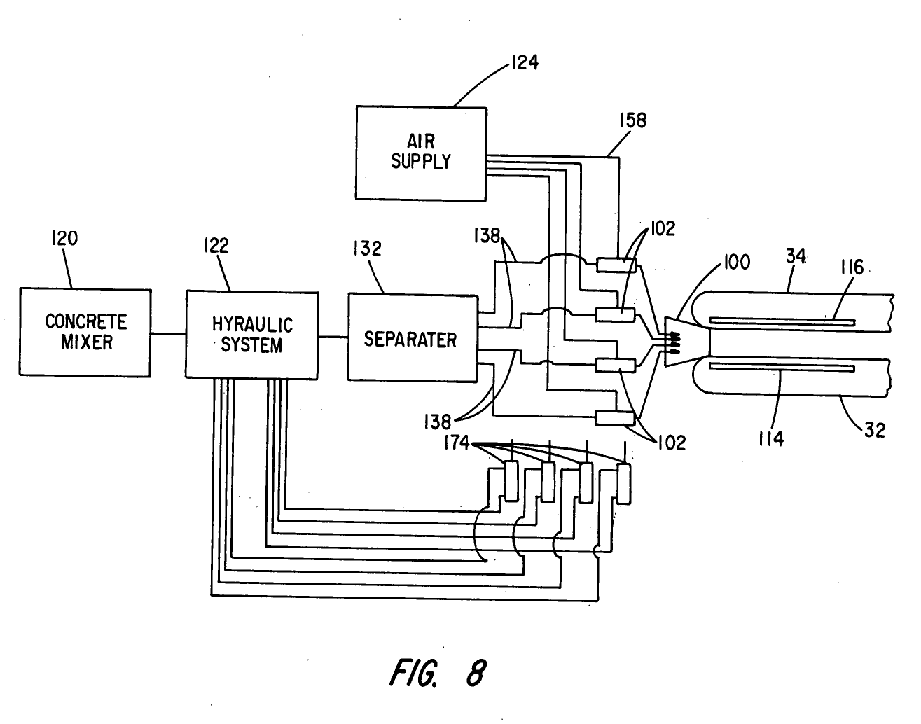

As seen in FIGS. 2A and 2B, the system further includes an infusion slot 100 in the form of a tapered vertical opening adapted to receive premixed concrete infused with high pressure air through a plurality of swiveling nozzles 102 which are supplied with pumped premixed concrete by a conventional concrete pump supplied from a ready mix plant using one or more mixers as at 120 in FIG. 8 in a well known manner. The concrete pump, in turn, pumps premixed concrete through a unique splitter arrangement to the infusion nozzles, as will be discussed.

The manufacturing plant or mechanized system further includes coils of reinforcing materials shown as primary wire-feeding coils 104 and back-up coils 106. A thermo-break feed is shown at 108. The system is further provided with an overpour return pipe 110, which returns overpoured material to the inlet side of the pump. A pair of vents are provided and vent pipes are depicted at 112. Steam manifolds used to supply steam along the length of the endless belts 32 and 34 are shown in part at 114 and 116 flanking the respective vertical side belts 32 and 34. The steam manifolds provide heat to accelerate the cure of the infused concrete panel material as it moves along the mechanized form.

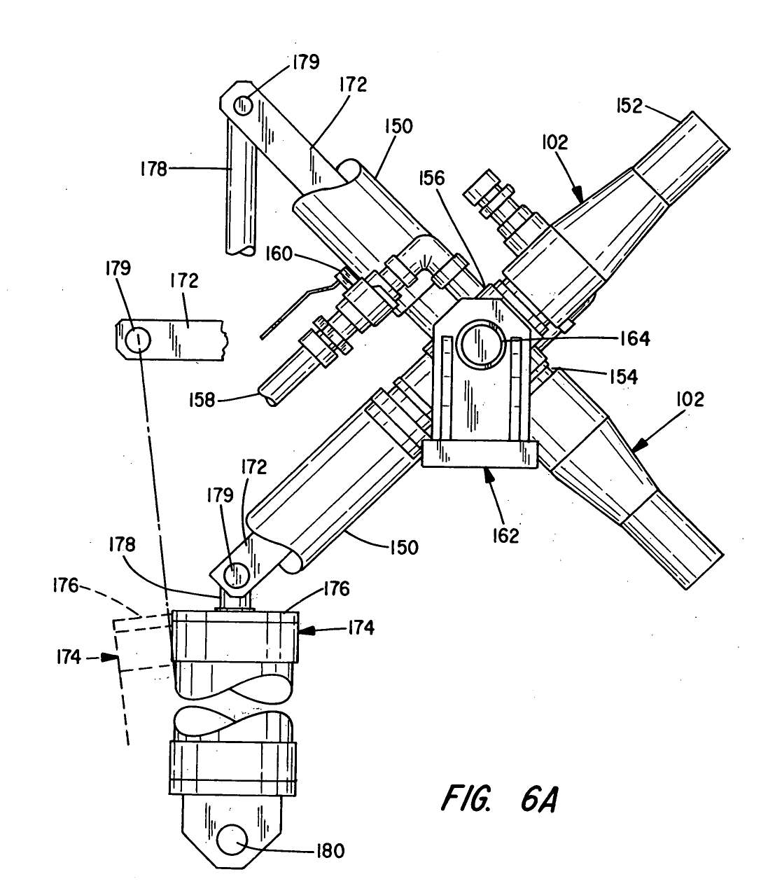

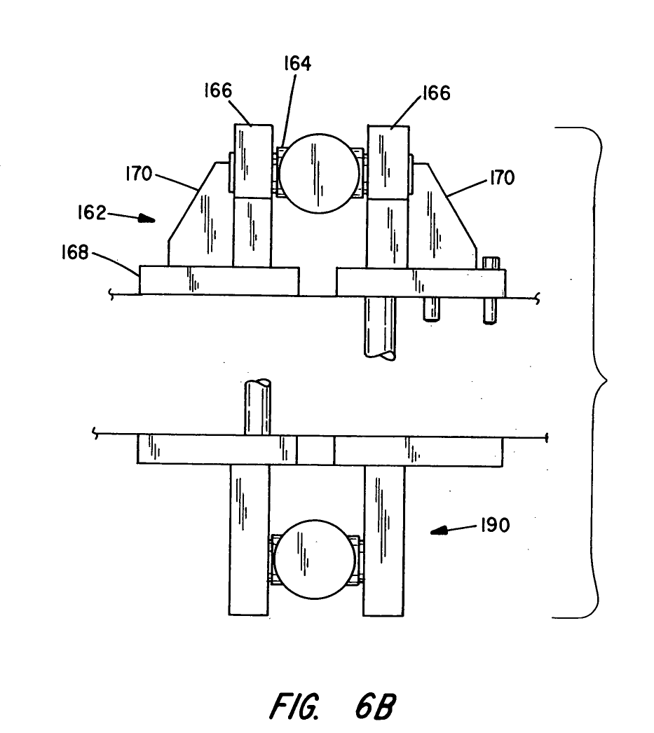

An important aspect of the present concept is contained in the premixed concrete supply or feed system, components of which are best shown in FIGS. 6A-6B, 7A-7B and 8.

Concrete of the desired formula and consistency can be obtained as from a conventional ready-mix plant, which may be a portable or permanently installed plant. A mixer is shown at 120 in FIG. 8. The schematic diagram of FIG. 8 further includes a conventional hydraulic system 122 that supplies high pressure hydraulic fluid to operate nozzle control manipulators and other devices in a conventional manner. The details are believe well-known to those skilled in the art. A conventional high pressure air supply is shown at 124.

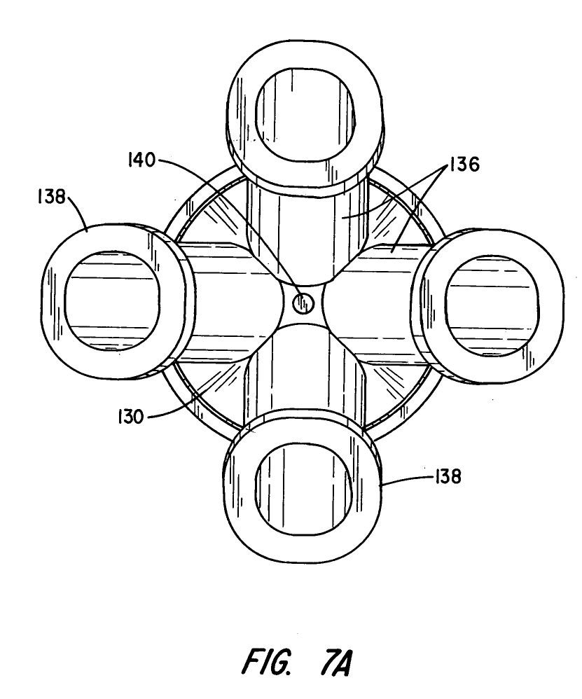

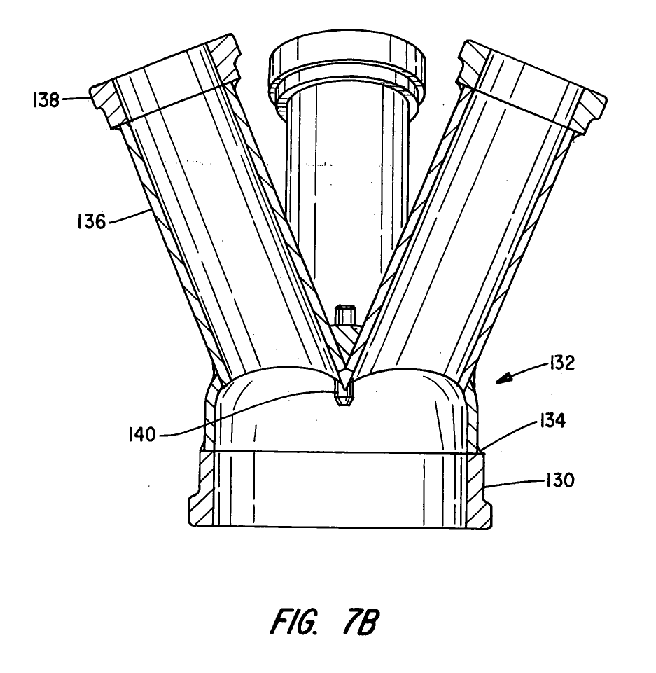

Pumping of ready-mixed concrete for building construction and other operations is well known in the art and a conventional pump may have an output line nominally 5 inches (12.7 cm) inside diameter. A fragment of an output line is shown at 130 in FIG. 7b and is welded to a stream splitter assembly 132 at 134. The splitter assembly includes four (4) off-chute pipes 136 provided with end fitting 138 adapted to receive heavy duty supply hoses, fragments of which are shown at 150 in FIG. 6a, and which connect each output or off-chute pipe with an infusion nozzle 102.

The splitter assembly 132 successfully divides the flow equally between the four off-chute pipes 136 in part due to the use of a central divider pin 140 which acts as a symmetrical flow diverter to incoming pumped concrete.

As indicated previously and seen in FIG. 6a, each infusion nozzle 102 is connected to a concrete supply hose 150. Each nozzle 102 may be provided with a tapered discharge nozzle attachment 152 which may be clamped to the nozzle over an end flange at 154. High pressure air is supplied to each nozzle 102 just before the discharge nozzle attachment as at 156. The air may be supplied by a conventional compressor system (not shown) through an air hose, a fragment of which is shown at 158, and also in FIG. 8, suitably valved at 160.

Each infusion nozzle is pivotally mounted in a fixed support as at 162, which may include a shaft journaled in a pair of mounts connected to a support base 168 strengthened by side plate members 170. Each infusion nozzle is pivoted using an attached member 172 which is pivotally connected to the rod end of a fluid cylinder 174 as at 176. A piston rod fragment is shown at 178 connected pivotally to member 172 at 179. The cylinder 174 is, in turn, pivotally mounted to a fixed mount at 180 so that it may follow the proper arc in pivoting the nozzle 102. Thus, extension and retraction of each cylinder rod 178 rotates the corresponding attached nozzle through its full vertical arc, which is generally about 90°. As shown in the drawing, four infusion nozzles 102 are typically provided in vertically spaced pairs of converging nozzles which together cover the entire length of the infusion slot 100 during a pivot cycle. The upper nozzles are typically mounted on an upward directed fixed support 162 and the lower nozzles on an inverted or downward directed fixed support of similar construction as is shown generally at 190.

In operation, the plant may be started up by first adjusting the width of the infusion chamber and introducing heat through the steam manifolds 112 to bring the plant up to temperature. At the same time, a batch of concrete is prepared and, when the system has reached the desired temperature, concrete is pumped to the infusion nozzles and high pressure air is supplied to the nozzles such that the nozzles can be operated and aerated mixed concrete can be infused at high pressure through the infusion slot 100. As the concrete panel material is infused through the infusion slot 100, the belts 32, 34, 36 are coordinated and controlled to move at the speed of the infusion of concrete as it fills the infusion chamber 30 from top to bottom by the swiveling action of the infusion nozzles.

Once the process begins, concrete may be supplied continuously and the material moved along the infusion chamber where heat and pressure effect a sufficient cure such that the material exiting the discharge end of the infusion chamber is sufficiently cured such that separated panel members are sufficiently solid to be handled in a vertical posture. Panels may be separated by the use of a concrete saw at the discharge end of the infusion chamber (not shown) or by other separation means used during the generation of the panel material.

It will be appreciated that fiber additives or other reinforcing material may be added to the concrete mix or to the material as the panels are formed as desired.

This invention has been described herein in considerable detail in order to comply with the patent statutes and to provide those skilled in the art with the information needed to apply the novel principles and to construct and use embodiments of the example as required. However, it is to be understood that the invention can be carried out by specifically different devices and that various modifications can be accomplished without departing from the scope of the invention itself.

What is claimed is:

1. A method of producing precast concrete panels comprising:
(a) providing a concrete casting system including a generally vertical infusion chamber in the form of a hollow form structure describing a panel shape determined by movable members and having an infusion slot at an entry end of said form;
(b) providing a source of premixed concrete panel material to said infusion slot; and
(c) infusing said premixed concrete under pressure into said hollow form through and along said slot while moving said movable members as said form structure is filled to create precast panels in accordance with the shape and movement of said movable members.

2. A method as in claim 1 further comprising introducing additional pressure to said infused premixed concrete of said precast panel by the action of pinch rollers in the form of belt pulleys at the entrance of said hollow form structure.

3. A method as in claim 1 further comprising heating said hollow form structure to reduce setup curing time in said premixed concrete.

4. A method as in claim 2 further comprising heating said hollow form structure to reduce setup curing time in said premixed concrete.

5. A method as in claim 1 further comprising introducing a shape to one or more edges of said panels to facilitate interconnection of panels.

6. A method as in claim 5 comprising introducing a tongue and groove shape to top and bottom edges of said precast panel during the formation thereof.

7. A method as in claim 1 further comprising infusing said premixed concrete with pressurized air.

8. A method as in claim 1 wherein said premixed concrete is infused through a plurality of nozzles moved along said infusion slot.

9. A method as in claim 6 wherein said plurality of nozzles include generally vertically spaced sets of pivotally mounted converging nozzles disposed to pivot generally vertically along said infusion slot

10. A method as in claim 7 including moving said nozzles along said infusion slot during infusion.

11. A method as in claim 8 further comprising infusing said premixed concrete with pressurized air.

12. A method as in claim 9 wherein said plurality of nozzles are disposed at a downward-directed angle of approximately 45°.

13. A method as in claim 1 wherein said precast concrete panel is created at approximately 1 foot per minute, and moving said movable members at the rate of panel generation.

14. A method as in claim 9 including supplying said plurality of nozzles by splitting an amount of premixed concrete from a single pumped source.

15. A method as in claim 1 further comprising severing said precast panel at desired lengths to create a plurality of panels.

16. A system for the continuous production of precast concrete panel material comprising:
(a) a housing;
(b) a generally vertical infusion chamber in the form of a hollow form structure describing a panel shape defined by movable members for receiving infused concrete, said infusion chamber being supported by said housing;
(c) an infusion slot at an entry end of said form for admitting premixed concrete to said hollow form structure;
(d) a source of pressurized, premixed concrete addressing said infusion slot and providing premixed concrete to form a continuous cast panel structure; and
(e) operating arrangement for operating progression of said movable members form and coordinating the infusion of said premixed concrete.

17. A system as in claim 16 wherein said movable members of said hollow form structure further comprise a plurality of supported endless belts enclosing said infused concrete and determining said panel shape.

18. A system as in claim 17 wherein said endless belts are supported on a series of intermeshing rollers supported by structural frame members.

19. A system as in claim 18 wherein said endless belts include a pair of spaced side belts and a bottom belt and a top belt.

20. A system as in claim 18 wherein said top and bottom belts include forms to impart a shape to edges of said panel to facilitate interconnection of panels

21. A system as in claim 20 wherein said shape is a tongue and groove configuration.

22. A system as in claim 16 further comprising a pair of pinch rollers at the entrance of said infusion chamber for further pressurizing said infused concrete in said hollow form structure.

23. A system as in claim 16 including devices for varying the thickness of a panel produced by said system.

24. A system as in claim 15 further comprising a source of heat for heating said infusion chamber.

25. A system as in claim 16 wherein said source of premixed concrete further comprises a pump and splitter arrangement feeding a plurality of infusion nozzles.

26. A system as in claim 25 wherein said plurality of infusion nozzles further comprises a plurality of pairs of spaced nozzles disposed at an angle with the vertical and with each other in each pair.

27. A system as in claim 25 further comprising a source of pressurized air connected to said infusion nozzles.

28. A method as in claim 1 further comprising adding reinforcing material to said concrete during infusion.
